(19) United States
(12) Patent Application Publication
(10) Pub. No.: US 2026/0175833 A1
(43) Pub. Date: Jun. 25, 2026

(54) DRIVING ASSISTANCE DEVICE

(71) Applicant: TOYOTA JIDOSHA KABUSHIKI KAISHA, Toyota-shi (JP)

(72) Inventor: Tomohiko FUTATSUGI, Toyota-shi (JP)

(73) Assignee: TOYOTA JIDOSHA KABUSHIKI KAISHA, Toyota-shi (JP)

(21) Appl. No.: 19/325,995

(22) Filed: Sep. 11, 2025

(30) Foreign Application Priority Data
Dec. 23, 2024 (JP) 2024-226004

(51) Int. Cl. B60W 30/09

(52) U.S. Cl. CPC B60W 30/09; B60W 2520/10; B60W 2540/06; B60W 2540/10; B60W 2540/12; B60W 2554/4041; B60W 2710/18; B60W 2720/106

(57) ABSTRACT

A processor of a driving assistance device can continue a deceleration assist process in a situation in which a state where a condition for executing the deceleration assist process is satisfied and a condition for executing a collision risk reduction process is not satisfied is maintained, to end execution of the deceleration assist process in a case where a speed of the host vehicle decreases to a threshold value by the deceleration assist process, and to execute a condition relaxation process of relaxing the condition for executing the collision risk reduction process.

### CROSS-REFERENCE TO RELATED APPLICATION

This application claims priority to Japanese Patent Application No. 2024-226004 filed on Dec. 23, 2024. The disclosure of the above-identified application, including the specification, drawings, and claims, is incorporated by reference herein in its entirety.

### BACKGROUND

### 1. Technical Field

The present disclosure relates to a driving assistance device having a function of braking a host vehicle such that excessive approach of the host vehicle to a preceding vehicle is suppressed and a function of controlling the host vehicle such that a collision risk between the host vehicle and the preceding vehicle is reduced in a case where the collision risk is increased.

### 2. Description of Related Art

A driving assistance device having a function of controlling a host vehicle such that an inter-vehicle distance between the host vehicle and a preceding vehicle matches a target value is proposed (for example, see Japanese Unexamined Patent Application Publication No. 2000-052806 (JP 2000-052806 A)). A processor of the device (hereinafter, referred to as a “related-art device”) determines a target value of the inter-vehicle distance based on speeds of the host vehicle and the preceding vehicle. The processor controls a drive device or a brake device of the host vehicle such that an actual measured value of the inter-vehicle distance between the host vehicle and the preceding vehicle matches the target value.

### SUMMARY

Examples of well-known functions of this kind of driving assistance device include a deceleration assist function (Deceleration Assist: DA) and a collision risk reduction function (PRe-Crash Safety: PCS).

The deceleration assist function is a function of automatically braking the host vehicle by the driving assistance device in a case where the preceding vehicle is present, the speed of the host vehicle is relatively high, and an accelerator pedal and a brake pedal are released. That is, the processor executes a process (deceleration assist process) of controlling the brake device of the host vehicle such that the host vehicle is gently braked in such a scene. The processor ends the deceleration assist process at a point when the speed of the host vehicle decreases and reaches a threshold value by executing the deceleration assist process. In this manner, behind the preceding vehicle, in a scene in which a driver does not execute a driving operation of adjusting the speed, the host vehicle is automatically braked (gently decelerated), and the speed of the host vehicle becomes low to a certain extent. Accordingly, excessive approach of the host vehicle to the preceding vehicle is suppressed.

The collision risk reduction function includes a warning function. The warning function is a function of issuing a predetermined warning for prompting the driver of the host vehicle to start a manual driving operation (collision avoidance action) for avoiding a collision in a case where time to collision (TTC) is equal to or less than a threshold value. The threshold value of the time to collision as an operation timing of the warning function is relatively small. Although a situation is rare in which the time to collision decreases and the threshold value is reached while the processor executes the deceleration assist process, the processor preferentially executes the collision risk reduction process in a case where this situation occurs. In addition, the collision risk reduction function includes an emergency brake function. The emergency brake function is a function of braking the host vehicle in a case where the collision risk is further increased from a point when the warning is issued by the warning function (a case where the time to collision further decreases and a decrease amount thereof reaches the threshold value).

The deceleration assist function is designed on the premise that the driver brakes the host vehicle by stepping on the brake pedal while the host vehicle is being braked (gentle-braked) by the deceleration assist function. That is, the deceleration assist function is merely a function of assisting a braking operation during a period in which the start of a driving operation of braking the host vehicle is slightly delayed. On the other hand, the collision risk reduction function is a function of reducing the collision risk in a case where an emergency situation where the collision risk between the host vehicle and the preceding vehicle is high occurs.

As described above, the deceleration assist function is a function of assisting the braking operation by the driver, but there is a concern that the driver may over-rely on the deceleration assist function and may not step on the brake pedal. In this case, the processor ends the deceleration assist process at a point when the speed of the host vehicle decreases and reaches the threshold value, and thus there is a concern that the host vehicle may travel in a state of being hardly braked from the point. Here, in a case where the driver is notified of the end (completion) of the process each time the deceleration assist process is ended due to the speed of the host vehicle decreasing and reaching the threshold value by the deceleration assist process, there is a concern that the driver may find the notification troublesome. Therefore, the processor of this kind of driving assistance device is configured not to issue notification of the end of the process even in a case where the deceleration assist process is ended. Therefore, there is a concern that the driver may not be aware that the deceleration assist process is ended, and the host vehicle may travel in a state of being hardly braked (a state of being extremely gently braked by an engine brake). In this case, the collision risk reduction function operates at a point when the time to collision decreases and the threshold value is reached. As described above, in a state where the driver is not aware that the host vehicle is traveling in a state of being hardly braked (a state where the driver's attention is lowered), the warning function as the collision risk reduction function may operate. In this case, there is a possibility that the driver cannot immediately respond to the warning (there is a possibility that the start of the collision avoidance action is delayed). In a case where a start condition of the collision risk reduction process is relatively strict (in a case where a relatively small value is assigned to the threshold value of the time to collision), a start timing of the warning process is relatively delayed. In addition, a start timing of the emergency brake process is also relatively delayed. Therefore, there is a concern that reduction of the collision risk by the driver's collision avoidance action and the emergency brake cannot be expected much.

The present disclosure provides a driving assistance device having the deceleration assist function and the collision risk reduction function. The present disclosure provides a driving assistance device that can efficiently reduce the collision risk between the host vehicle and the preceding vehicle in a scene in which the collision risk reduction function operates after braking of the host vehicle by the deceleration assist function is ended.

A driving assistance device according to the present disclosure includes:
an in-vehicle sensor for acquiring information on an object positioned forward of a host vehicle; and
a processor configured to execute a deceleration assist process of braking the host vehicle in a case where a preceding vehicle is present and a first condition for determining that there is a high possibility that the host vehicle excessively approaches the preceding vehicle is satisfied, and a collision risk reduction process of controlling the host vehicle such that a collision risk between the host vehicle and the preceding vehicle is reduced in a case where a second condition that is a condition for determining that the collision risk is high is satisfied, and end execution of the deceleration assist process in a case where the first condition is not satisfied or the second condition is satisfied during the execution of the deceleration assist process.
   The processor is configured to end the execution of the deceleration assist process and execute a condition relaxation process of relaxing the second condition, in a case where a speed of the host vehicle decreases and reaches a threshold value due to continuation of the deceleration assist process under a situation in which a state where the first condition is satisfied and the second condition is not satisfied is maintained.

In a case where another vehicle (preceding vehicle) is present forward of the vehicle (host vehicle) to which the driving assistance device according to the present disclosure is applied, and the first condition is satisfied, the host vehicle is automatically decelerated due to execution of the deceleration assist process. Thereafter, the deceleration assist process is ended at a point when the speed of the host vehicle reaches the threshold value by the deceleration assist process. At this point in time, the processor relaxes the second condition that is a start condition of the collision risk reduction process. In a case where the driver of the host vehicle is not aware that the deceleration assist process is ended, and the host vehicle travels in a state of being hardly braked and further approaches the preceding vehicle, the collision risk reduction process is started in a state where a temporal margin is relatively large (at a relatively early timing). Accordingly, the collision risk between the host vehicle and the preceding vehicle can be efficiently reduced.

In the driving assistance device according to an aspect of the present disclosure, the processor is configured to execute, in a case where a predetermined operation device is operated, a customization process of setting a strictness level of the second condition in accordance with an operation mode of the predetermined operation device; and

the condition relaxation process includes a process of changing, in a case where the strictness level of the second condition set in accordance with the operation mode is the same as or stricter than a first strictness level that is predetermined, the strictness level of the second condition to a second strictness level that is a strictness level relaxed relative to the first strictness level.

Accordingly, in a case where the strictness level of the second condition is the same as or stricter than the first strictness level (for example, a standard value), the strictness level of the second condition is changed to the second strictness level that is a strictness level relaxed relative to the first strictness level by the condition relaxation process. On the other hand, in a case where the strictness level of the second condition matches the second strictness level, the strictness level of the second condition is not changed.

In the driving assistance device according to the aspect of the present disclosure,
the processor is configured to maintain, after relaxing the second condition by the condition relaxation process, a state where the second condition is relaxed, until an ignition switch of the host vehicle transitions to an off state, and return the second condition to a state before the condition relaxation process is executed, at a point when the ignition switch transitions from the off state to an on state.

Accordingly, in a case where the driver once ends driving of the host vehicle and then restarts the driving of the host vehicle, the second condition is automatically restored.

In the driving assistance device according to the aspect of the present disclosure,
the processor is configured to determine that the first condition is satisfied in a case where the speed of the host vehicle exceeds a predetermined value, and an accelerator pedal and a brake pedal of the host vehicle are released.

In a case where the speed of the host vehicle is relatively high and the driver does not execute an operation of adjusting the speed of the host vehicle, the host vehicle travels in a state of being hardly braked (a state of being extremely gently decelerated by the engine brake). The processor of the driving assistance device according to the present aspect determines that the first condition is satisfied in such a situation, and starts the deceleration assist process. Accordingly, excessive approach of the host vehicle to the preceding vehicle is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a driving assistance device according to an embodiment of the present disclosure;

FIG. 2 is a side view showing a positional relationship between a host vehicle and a preceding vehicle in a case where a deceleration assist process is not executed, and a positional relationship between the host vehicle and the preceding vehicle in a case where the deceleration assist process and a risk reduction process are executed;

FIG. 3 is an example of an image (upper image) displayed on an image display device in a state where a start timing (start condition) of a collision risk reduction process is set to “late”, and an image (lower image) displayed on the image display device in a state where the start timing is forcibly changed to “early”;

FIG. 4 is a flowchart of a first program executed by a CPU in order to implement a function of changing the start condition of the collision risk reduction process in accordance with a scene;

FIG. 5 is a flowchart of a second program executed by the CPU in order to implement the function of changing the start condition of the collision risk reduction process in accordance with a scene; and

FIG. 6 is a flowchart of a third program executed by the CPU in order to implement the function of changing the start condition of the collision risk reduction process in accordance with a scene.

### DETAILED DESCRIPTION OF EMBODIMENTS

### Overview

A driving assistance device 1 according to an embodiment of the present disclosure is applied to a vehicle V0 (hereinafter, referred to as “host vehicle”) having an autonomous driving function. The driving assistance device 1 has the above-described deceleration assist function and collision risk reduction function. The driving assistance device 1 has a function of forcibly relaxing a condition for starting the collision risk reduction process in a case where the deceleration assist process is ended (completed) without interruption after the deceleration assist process is started.

### Specific Configuration

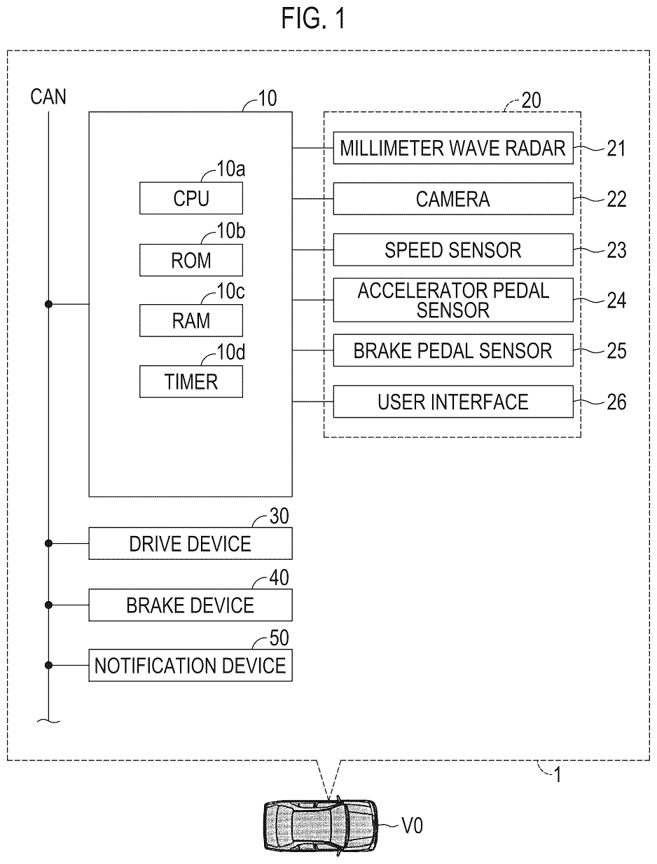

As illustrated in FIG. 1, the driving assistance device 1 comprises an ECU 10, an in-vehicle sensor 20, a notification device 30, a drive device 40, and a brake device 50.

The ECU 10 includes a microcomputer comprising a CPU 10a, a ROM 10b, a RAM 10c, a timer 10d, and the like. The ECU 10 is connected to another ECU via a communication network (CAN).

The in-vehicle sensor 20 includes a millimeter wave radar 21, a camera 22, a speed sensor 23, an accelerator pedal sensor 24, a brake pedal sensor 25, and a user interface 26.

The millimeter wave radar 21 comprises a transmission and reception unit and a signal processing unit (not illustrated). The transmission and reception unit radiates a radio wave in a millimeter wave band (hereinafter, referred to as “millimeter wave”) to a front region of the host vehicle and receives the millimeter wave (reflected wave) reflected by a three-dimensional object (preceding vehicle V1) positioned within a radiation range. The signal processing unit calculates a distance between the host vehicle and the three-dimensional object (preceding vehicle V1), a speed (relative speed vr) of the three-dimensional object with respect to the host vehicle, and the like. The signal processing unit calculates the distance between the host vehicle and the three-dimensional object and the speed of the three-dimensional object with respect to the host vehicle based on a time from radiation of the millimeter wave to reception of the reflected wave by the transmission and reception unit, a phase difference between the transmitted millimeter wave and the received reflected wave, an attenuation level of the reflected wave, and the like. The signal processing unit provides calculation results to the ECU 10.

The camera 22 comprises an imaging device and an image analysis device. The imaging device incorporates a lens and a charge coupled device (CCD) or a CMOS image sensor (CIS) as an imaging element. The imaging device is installed at a front portion of the host vehicle and faces forward. The imaging device images the front region of the host vehicle at a predetermined frame rate to acquire image data. The imaging device transmits the image data to the image analysis device. The image analysis device analyzes the acquired image data to acquire information on an object positioned in front of the host vehicle from the image. For example, the image analysis device identifies the preceding vehicle V1 and other objects. The image analysis device provides the identification result (recognition result) to the ECU 10.

The speed sensor 23 detects a rotation speed (wheel speed) of each wheel and calculates a speed sp0 (actual measured value) of the host vehicle based on each wheel speed. The speed sensor 23 provides the calculation result to the ECU 10.

The accelerator pedal sensor 24 detects a stepping depth AD (accelerator opening amount) of the accelerator pedal and provides a detection result to the ECU 10. The brake pedal sensor 25 detects a stepping depth BD of the brake pedal and provides a detection result to the ECU 10.

The user interface 26 includes an image display device, a touch panel, and the like. The user interface 26 is used for an operation of selecting a strictness level (sensitivity) of a condition under which the ECU 10 starts a collision risk reduction process described later.

The notification device 30 includes the image display device and an audio device. The image display device acquires an image display command from the ECU 10 and displays an image (for example, an image indicating that a collision risk between the host vehicle and the preceding vehicle V1 is high) in accordance with the command. The image display device of the notification device 30 and the image display device of the user interface 26 may be used in combination. In addition, the audio device acquires a voice reproduction command from the ECU 10 and reproduces a voice (for example, a voice indicating that the collision risk between the host vehicle and the preceding vehicle V1 is high) in accordance with the command.

The drive device 40 applies a driving force to a driving wheel. The drive device 40 includes an engine ECU, an internal combustion machine, a transmission machine, a driving force transmission mechanism that transmits a driving force to a wheel, and the like. The engine ECU acquires information (target value) indicating a target driving force from another ECU (ECU 10). The engine ECU drives a throttle valve of the internal combustion machine to cause the driving force applied to the driving wheel to match the target value.

A vehicle to which the driving assistance device 1 is applied may be a hybrid electric vehicle (HEV). In this case, the engine ECU can adjust an output (driving force) of any one or both of “an internal combustion machine and an electric motor” as a vehicle driving source. In addition, in a case where the vehicle to which the driving assistance device 1 is applied is an electric vehicle (BEV), a motor ECU that adjusts an output (driving force) of “a motor” as a vehicle driving source is used instead of the engine ECU.

The brake device 50 applies a braking force to the wheel (brake disk). The brake device 50 includes a brake ECU, a brake caliper, and the like. The brake caliper includes an actuator that presses a brake pad against the brake disk. The brake ECU acquires information (target value) indicating a target braking force (or a deceleration of the host vehicle) from another ECU. The brake ECU drives the actuator of the brake caliper to cause the braking force (or the deceleration of the host vehicle) applied to the wheel (brake disk) to match the target value. In a case where the stepping depths BD of the accelerator pedal and the brake pedal are “0”, a braking force by an engine brake is applied to the host vehicle.

### Operation

The driving assistance device 1 has a deceleration assist function (a function of executing a deceleration assist process via the ECU 10) and a collision risk reduction function (a function of executing a warning process and an emergency brake process via the ECU 10).

### Deceleration Assist Function (DA)

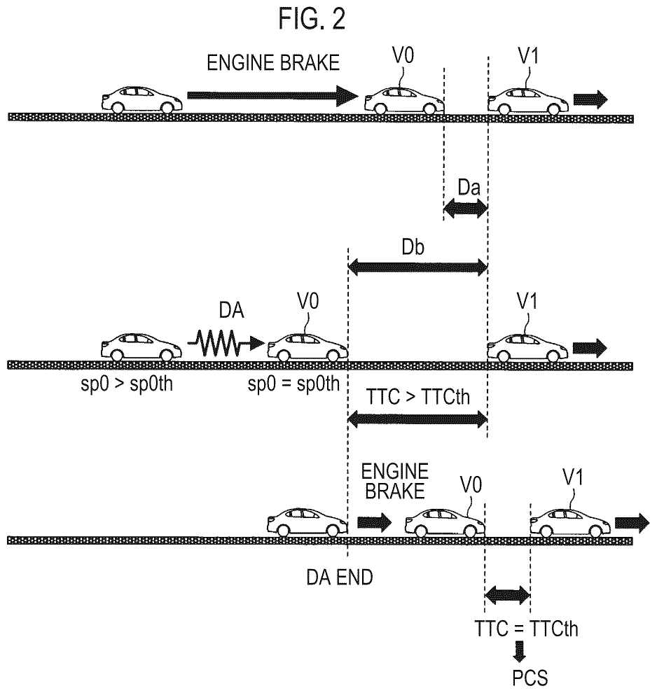

In a scene in which a preceding vehicle V1 is present in front of the host vehicle, in a case where the host vehicle travels in a state of being hardly braked, there is a concern that the host vehicle may excessively approach the preceding vehicle V1. The state where the host vehicle is hardly braked is a state where the host vehicle is decelerated extremely gently by an engine brake. That is, as illustrated in an uppermost illustration in FIG. 2, there is a concern that an inter-vehicle distance D may be excessively small (D=Da<Db (Db: a value defined in advance as a safe distance)). Therefore, in a scene in which the preceding vehicle V1 is present, the ECU 10 executes the deceleration assist process of braking the host vehicle such that excessive approach of the host vehicle to the preceding vehicle V1 is suppressed in a case where a predetermined condition X (first condition according to the embodiment of the present disclosure) is satisfied. The ECU 10 determines that the condition X is satisfied in a case where the following condition X1 and condition X2 are satisfied.

Condition X1 . . . a speed sp0 exceeds a threshold value sp0th (for example, 20 km/h). Condition X2 . . . a driver of the host vehicle does not execute an operation of adjusting the speed sp0 (the accelerator pedal and the brake pedal are released (AD=0 and BD=0)). The ECU 10 executes a gentle braking process of controlling the brake device 50 such that the host vehicle is gently braked, as the deceleration assist process. For example, the ECU 10 controls the drive device or the like such that the deceleration of the host vehicle matches a predetermined value. In a scene in which the inter-vehicle distance between the host vehicle and the preceding vehicle V1 tends to decrease, the ECU 10 sequentially calculates (updates) the target value of the braking force such that the speed sp0 matches the threshold value sp0th at a point in time when the host vehicle reaches a predetermined position behind the preceding vehicle V1. Alternatively, the ECU 10 sequentially calculates (updates) the target value of the deceleration of the host vehicle such that the speed sp0 matches the threshold value sp0th at a point in time when the host vehicle reaches a predetermined position behind the preceding vehicle V1. The predetermined position behind the preceding vehicle V1 is a point at which the inter-vehicle distance D matches a predetermined value Db (>Da). Then, the ECU 10 may transmit the calculated target value to the brake device 50. The ECU 10 detects the preceding vehicle V1 based on information acquired from the millimeter wave radar 21 and the camera 22, but a detectable distance (maximum value) thereof is relatively large. For example, in a case where the inter-vehicle distance D is 100 meters or less, the ECU 10 can accurately detect the preceding vehicle V1. In this way, the ECU 10 can start the deceleration assist process from a state where the inter-vehicle distance D is relatively large. Therefore, the deceleration (absolute value) of the host vehicle during execution of the deceleration assist process is generally a bit larger than the deceleration in a case where the host vehicle is decelerated only by an engine brake, and the deceleration is so-called emergency braking that makes an occupant uncomfortable is rare.

In a case where the vehicle V0 (host vehicle) to which the driving assistance device 1 is applied is a hybrid electric vehicle or a battery electric vehicle, a well-known regenerative system operates instead of (or in addition to) the brake device 50. Accordingly, the host vehicle may be decelerated.

The ECU 10 continues the deceleration assist process during a period in which the condition X1 and the condition X2 are satisfied. Accordingly, in a case where the speed sp0 decreases and the condition X1 is not satisfied, the deceleration assist process is ended (completed).

Here, the deceleration assist function is a function on the premise that the driver brakes the host vehicle by stepping on the brake pedal before the speed sp0 reaches the threshold value sp0th by automatic braking of the host vehicle by the function. Therefore, there is a high possibility that the brake pedal is stepped on during execution of the deceleration assist process, and the condition X2 is not satisfied. In this case, the ECU 10 ends (interrupts) execution of the deceleration assist process. In addition, the ECU 10 ends (interrupts) execution of the deceleration assist process even in a case where it is detected that the accelerator pedal is stepped on during execution of the deceleration assist process. In this case, the ECU 10 controls the drive device 40 such that the host vehicle is accelerated at an acceleration corresponding to the stepping depth of the accelerator pedal. In addition, as will be described in detail later, the ECU 10 ends (interrupts) execution of the deceleration assist process even in a case where the collision risk reduction process to be described below is started during execution of the deceleration assist process.

### Collision Risk Reduction Function (PCS)

In a case where the following condition Y (second condition according to the embodiment of the present disclosure) is satisfied, the ECU 10 controls the notification device 30 and the brake device 50 such that a collision risk between the host vehicle and the preceding vehicle is reduced.

Condition Y . . . a time (collision margin time TTC (=D/spr)) predicted to be required until the host vehicle reaches a rear end of the preceding vehicle V1 is equal to or less than a threshold value TTCth.
In a case where the condition Y is satisfied, the ECU 10 executes the risk reduction process (see a lowermost illustration in FIG. 2). That is, the ECU 10 causes the notification device 30 to display an image indicating that the collision risk between the host vehicle and the preceding vehicle V1 is high and to reproduce a voice indicating that the risk is high (warning process). In a case where the collision risk is further increased from a point in time when execution of the warning process is started, the ECU 10 controls the brake device 50 such that a relatively large braking force is applied to the wheel of the host vehicle (emergency brake process). The case where the collision risk is further increased from the point in time when execution of the warning process is started is a case where the collision margin time TTC is further decreased and a decrease amount ΔTTC reaches a threshold value ΔTTCth.

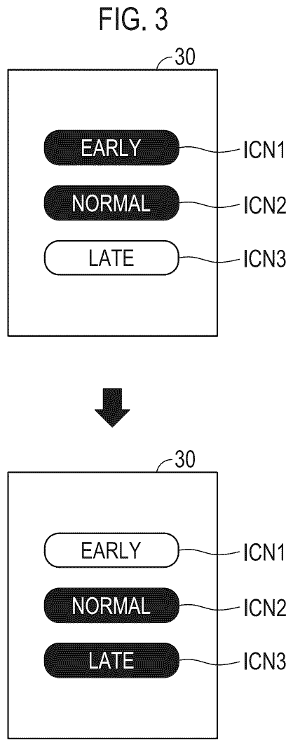

Here, the threshold value TTCth corresponds to a start timing Ts of the collision risk reduction process (strictness level of the start condition of the collision risk reduction process). The driver can set (change) the start timing Ts by using the user interface 26. That is, the ECU 10 executes a process (customization process) of changing the start timing Ts in accordance with an operation of the driver. Specifically, as illustrated in an upper image of FIG. 3 and a lower image of FIG. 3, the ECU 10 displays icons ICN1, ICN2, and ICN3 on the image display device of the user interface 26. The icons ICN1, ICN2, and ICN3 correspond to “early”, “normal”, and “late” as options of the start timing Ts, respectively. In a case where the driver selects “normal” (in a case where the icon ICN2 is tapped), the ECU 10 assigns a standard value TTCstd to the threshold value TTCth. In a case where the driver selects “early”, the ECU 10 assigns a predetermined value TTCmax, which is larger than the standard value, to the threshold value TTCth. Accordingly, a state where the start condition of the collision risk reduction process is relaxed is achieved compared to a case where “normal” is selected. In a case where the driver selects “late” (in the upper image of FIG. 3), the ECU 10 assigns a predetermined value TTCmin, which is smaller than the standard value TTCstd, to the threshold value TTCth. Accordingly, a state where the start condition of the collision risk reduction process is made stricter is achieved compared to a case where “normal” is selected. In a case where the driver selects the start timing Ts of the collision risk reduction process by using the user interface 26, a selection result is stored in the ROM 10b. That is, the threshold value TTCth is written into the ROM 10b (flash memory) as a threshold value TTCmem. In a case where an ignition switch transitions from an off state to an on state, the ECU 10 reads out the threshold value TTCmem from the ROM 10b and assigns the read threshold value TTCmem to the threshold value TTCth.

Meanwhile, by executing the deceleration assist process, the collision margin time TTC is relatively gently decreased. During execution of the deceleration assist process, the collision margin time TTC may be substantially constant (unchanged) or may be increased. It is rare that the collision margin time TTC decreases to reach the threshold value TTCth (predetermined value TTCmax) while the ECU 10 is executing the deceleration assist process. However, in a case where the collision margin time TTC reaches the threshold value TTCth during execution of the deceleration assist process, the ECU 10 preferentially executes the collision risk reduction process.

At a point in time when the speed sp0 reaches the threshold value sp0th without interruption of the deceleration assist process, the ECU 10 ends (completes) execution of the deceleration assist process. That is, at a point in time when the speed sp0 reaches the threshold value sp0th in a state where the brake pedal and the accelerator pedal are not stepped on during the deceleration assist process and the start condition of the collision risk reduction process is not satisfied, the ECU 10 ends (completes) execution of the deceleration assist process. Information indicating the end (completion) of the deceleration assist process is not provided to the driver. Therefore, there is a concern that the driver may not notice that the deceleration assist process has ended (completed), and the host vehicle may travel in a state where the host vehicle is hardly braked (a state where the host vehicle is extremely gently decelerated by an engine brake). In this case, the collision risk reduction function operates at a point in time tpcs at which the collision margin time TTC decreases to reach the threshold value TTCth. As described above, in a state where the driver is not aware that the host vehicle is traveling in a state of being hardly braked (a state where the driver's attention is lowered), the warning function as the collision risk reduction function may operate. In this case, the driver may not be able to immediately respond to the warning (in a case where the collision avoidance action is delayed). Therefore, as described above, in a situation in which the driver's attention is lowered due to execution of the deceleration assist process, it is preferable that the start timing Ts of the collision risk reduction process is as early as possible.

Therefore, in a case where “normal” or “late” is selected as the start timing of the collision risk reduction process at a point in time when the condition X1 is not satisfied during execution of the deceleration assist process, the ECU 10 executes the condition relaxation process. The condition relaxation process is a process of forcibly changing the start timing Ts to “early”. The condition relaxation process is, for example, a process of effecting a transition from the upper image of FIG. 3 to the lower image of FIG. 3. That is, the ECU 10 forcibly relaxes the start condition of the collision risk reduction process. Accordingly, the warning process is started at a point in time when there is a certain margin until the host vehicle reaches the rear end of the preceding vehicle V1. Therefore, even in a case where it takes a little time from a point in time when the warning is issued to a point in time when the driver starts a collision avoidance action, the collision margin time TTC at a start point in time of the collision avoidance action is relatively large, and the collision avoidance action is continued. Accordingly, the collision risk is efficiently reduced. Even in a case where the collision avoidance action is not started, the emergency brake process is started at a relatively early timing. Therefore, the collision risk is efficiently reduced.

In a case where the start timing Ts of the collision risk reduction process is forcibly relaxed, the ECU 10 maintains the state (TTCth=TTCmax) until the ignition switch is in the off state. Then, in a case where the ignition switch transitions from the off state to the on state, the ECU 10 reads out the threshold value TTCmem (start timing Ts selected by the driver last time) from the ROM 10b and assigns the value to the threshold value TTCth. In a case where the driver changes the start timing Ts during a period from a point in time when the start timing of the collision risk reduction process is forcibly relaxed to a point in time when the ignition switch transitions to the off state, the ECU 10 changes the start timing Ts in accordance with the operation. The case where the driver changes the start timing Ts is a case where the driver selects “normal” or “late”.

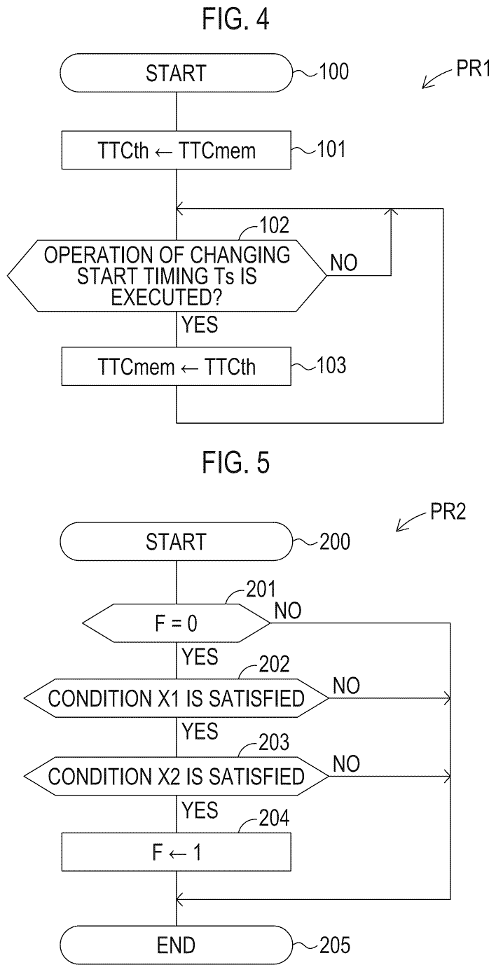

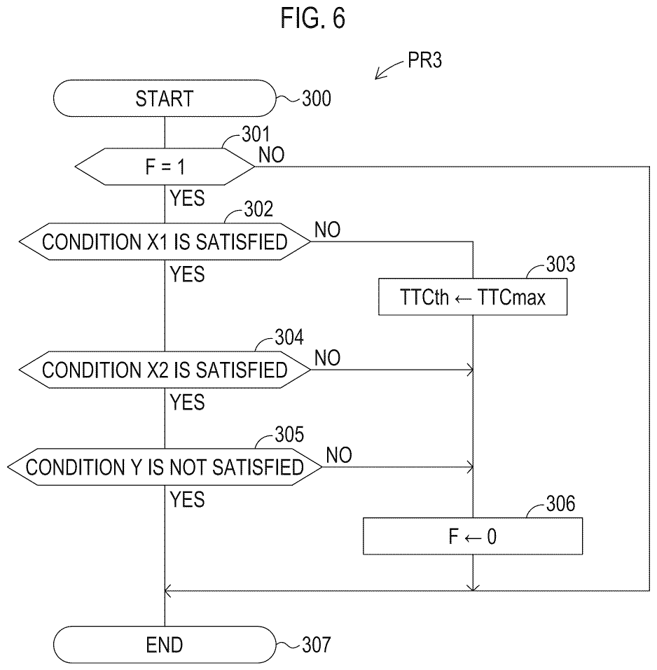

Next, programs PR1 to PR3 executed by the CPU 10a of the ECU 10 (hereinafter, simply referred to as “CPU”) in order to implement a function of automatically changing the start timing Ts of the collision risk reduction process will be described with reference to FIGS. 4 to 6. In a case where the ignition switch transitions from an off state to an on state, the ECU 10 starts execution of the program PR1. In addition, the ECU 10 starts execution of the program PR2 and the program PR3 in a predetermined cycle in a situation in which the preceding vehicle V1 is detected. A flag F is used in the program PR2 and the program PR3. The flag F indicates whether or not the CPU is executing the deceleration assist process. In a case where the CPU is executing the deceleration assist process, “1” is assigned to the flag F. In a case where the CPU is not executing the deceleration assist process, “0” is assigned to the flag F.

### Program PR1

The Cpu Starts Execution of the Program PR1 From Step 100 and Proceeds to step 101.

In step 101, the CPU reads out the threshold value TTCmem (value corresponding to the start timing Ts selected last time) of the collision margin time TTC from the ROM 10b and assigns the value to the threshold value TTCth. Then, the CPU proceeds to step 102.

In step 102, the CPU determines whether or not an operation of changing the start timing Ts is executed. In a case where it is determined that the operation is executed (102: Yes), the CPU proceeds to step 103. On the other hand, in a case where it is determined that the operation is not executed (102: No), the CPU returns to step 102.

In step 103, the CPU stores the threshold value TTCth (TTCmin/TTCstd/TTCmax) corresponding to a current start timing Ts in the ROM 10b (flash memory) as the threshold value TTCmem. The current start timing Ts is the start timing Ts selected by the driver. Then, the CPU returns to step 102.

### Program PR2

The Cpu Starts Execution of the Program PR2 From Step 200 and Proceeds to step 201.

In step 201, the CPU determines whether or not the flag F is “0”. In a case where it is determined that the flag F is “0” (201: Yes), the CPU proceeds to step 202. On the other hand, in a case where it is determined that the flag F is not “0” (201: No), the CPU proceeds to step 205.

In step 202, the CPU determines whether or not the condition X1 is satisfied. In a case where it is determined that the condition X1 is satisfied (202: Yes), the CPU proceeds to step 203. On the other hand, in a case where it is determined that the condition X1 is not satisfied (202: No), the CPU proceeds to step 205.

In step 203, the CPU determines whether or not the condition X2 is satisfied. In a case where it is determined that the condition X2 is satisfied (203: Yes), the CPU proceeds to step 204. On the other hand, in a case where it is determined that the condition X2 is not satisfied (203: No), the CPU proceeds to step 205.

In step 204, the CPU sets the flag F to “1”. In this case, the CPU executes a deceleration assist program (not illustrated) to control the brake device 50 such that the braking force (deceleration) of the host vehicle matches the target value (gentle braking process). Then, the CPU proceeds to step 205, and ends execution of the program PR2 in step 205.

### Program PR3

The CPU starts execution of the program PR3 from step 300 and proceeds to step 301.

In step 301, the CPU determines whether or not the flag F is “1”. In a case where it is determined that the flag F is “1” (301: Yes), the CPU proceeds to step 302. On the other hand, in a case where it is determined that the flag F is not “1” (301: No), the CPU proceeds to step 307.

In step 302, the CPU determines whether or not the condition X1 is satisfied. In a case where it is determined that the condition X1 is satisfied (302: Yes), the CPU proceeds to step 304. On the other hand, in a case where it is determined that the condition X1 is not satisfied (302: No), the CPU proceeds to step 303.

In step 303, the CPU assigns the predetermined value TTCmax to the threshold value TTCth. Then, the CPU proceeds to step 306.

In step 304, the CPU determines whether or not the condition X2 is satisfied. In a case where it is determined that the condition X2 is satisfied (304: Yes), the CPU proceeds to step 305. On the other hand, in a case where it is determined that the condition X2 is not satisfied (304: No), the CPU proceeds to step 306.

In step 305, the CPU determines whether or not the condition Y is not satisfied. In a case where it is determined that the condition Y is not satisfied (305: Yes), the CPU proceeds to step 307. On the other hand, in a case where it is determined that the condition Y is satisfied (305: No), the CPU proceeds to step 306. In a case where the CPU proceeds to step 306 from step 305, the CPU executes a warning program (not illustrated) to control the notification device 30 such that a predetermined warning is issued. In addition, the CPU executes an emergency brake program to control the brake device 50 such that the host vehicle is suddenly braked.

In step 306, the CPU sets the flag F to “0” and proceeds to step 307. The CPU ends execution of the program PR3 in step 307.

### Effect

In a case where the condition X is satisfied in a situation in which the preceding vehicle V1 is present in front of the host vehicle to which the driving assistance device 1 is applied, the deceleration assist process is executed. Accordingly, the host vehicle is automatically decelerated. The deceleration assist process is ended at a point in time when the condition X1 is not satisfied during execution of the deceleration assist process. At this point in time, in a case where “normal” or “late” is selected as the start timing Ts of the collision risk reduction process, the ECU 10 changes the start timing Ts to “early”. That is, the ECU 10 forcibly relaxes the condition Y which is the start condition of the collision risk reduction process. In some cases, the driver of the host vehicle does not notice the end of the deceleration assist process, and the host vehicle travels in a state of being hardly braked and approaches the preceding vehicle V1. With the above configuration, in this case, the collision risk reduction process is started in a state where a temporal margin is relatively large (at a relatively early timing). Therefore, the collision risk between the host vehicle and the preceding vehicle V1 can be efficiently reduced.

### Modification

In the above embodiment, the ECU 10 does not change the value assigned to the threshold value TTCth in a scene in which “early” is selected as the start timing Ts of the collision risk reduction process at a point in time when the condition X1 is not satisfied during execution of the deceleration assist process. Instead of this, in the scene, the ECU 10 may assign a predetermined value TTCex larger than the predetermined value TTCmax to the threshold value TTCth.

What is claimed is:

1. A driving assistance device comprising:
an in-vehicle sensor for acquiring information on an object positioned forward of a host vehicle; and
a processor configured to execute a deceleration assist process of braking the host vehicle in a case where a preceding vehicle is present and a first condition for determining that there is a high possibility that the host vehicle excessively approaches the preceding vehicle is satisfied, and a collision risk reduction process of controlling the host vehicle such that a collision risk between the host vehicle and the preceding vehicle is reduced in a case where a second condition that is a condition for determining that the collision risk is high is satisfied, and end execution of the deceleration assist process in a case where the first condition is not satisfied or the second condition is satisfied during the execution of the deceleration assist process,
wherein the processor is configured to end the execution of the deceleration assist process and execute a condition relaxation process of relaxing the second condition, in a case where a speed of the host vehicle decreases and reaches a threshold value due to continuation of the deceleration assist process under a situation in which a state where the first condition is satisfied and the second condition is not satisfied is maintained.

2. The driving assistance device according to claim 1, wherein:
the processor is configured to execute, in a case where a predetermined operation device is operated, a customization process of setting a strictness level of the second condition in accordance with an operation mode of the predetermined operation device; and
the condition relaxation process includes a process of changing, in a case where the strictness level of the second condition set in accordance with the operation mode is the same as or stricter than a first strictness level that is predetermined, the strictness level of the second condition to a second strictness level that is a strictness level relaxed relative to the first strictness level.

3. The driving assistance device according to claim 2, wherein the processor is configured to maintain, after relaxing the second condition by the condition relaxation process, a state where the second condition is relaxed, until an ignition switch of the host vehicle transitions to an off state, and return the second condition to a state before the condition relaxation process is executed, at a point when the ignition switch transitions from the off state to an on state.

4. The driving assistance device according to claim 1, wherein the processor is configured to determine that the first condition is satisfied in a case where the speed of the host vehicle exceeds a predetermined value, and an accelerator pedal and a brake pedal of the host vehicle are released.
